(19) United States
(12) Patent Application Publication
(10) Pub. No.: US 2013/0223355 A1
(43) Pub. Date: Aug. 29, 2013

(54) METHOD FOR IMPLEMENTING POWER GRANT ALLOCATION IN A MAC SCHEDULER

(71) Applicant: Ido Gazit, Haifa (IL)

(72) Inventor: Ido Gazit, Haifa (IL)

(21) Appl. No.: 13/408,195

(22) Filed: Feb. 29, 2012

(51) Int. Cl. H04W 72/04

(52) U.S. Cl. 370/329

(57) ABSTRACT

An apparatus comprising a first circuit and a second circuit. The first circuit may be configured to generate an estimated power unit table used to store power information in response to one or more of a plurality of input parameters. The second circuit may be configured to individually allocate one or more power usage parameters to each of a plurality of mobile units through a wireless network in response to the parameters stored in said power unit table. The power usage parameters may comprise (i) an absolute power grant when in a first mode and (ii) a relative power grant when in a second mode.

### FIELD OF THE INVENTION

The present invention relates to mobile communications generally and, more particularly, to a method and/or apparatus for implementing a power grant allocation in a MAC scheduler.

### BACKGROUND OF THE INVENTION

In order to improve cell capacity of WCDMA cellular system, additional features were added to the various specifications. Two such features include a Hybrid Automatic Repeat request (HARQ) processes and a MAC scheduler. The main idea behind the HARQ processes is to enable a fast retransmission mechanism of packets when retransmission is needed because a previous transmission of a packet failed.

In early WCDMA systems (such as rel-99), the scheduler entity was located on the on the Radio Network Controller (RNC). The RNC determined the transport format combination (TFC), while for each transmitted time interval (TTI) the base station (for DL) and the UE (for UL) select one index from the TFC table (TFCI). The criteria for the TFCI selection are the logical channels priorities, logical channels Buffer Occupancy (BO) and power restrictions.

The main disadvantage of the rel-99 scheduler is that channel capacity is not used efficiently, because the scheduler does not take into account the channel quality on a TTI basis. The further a radio network controller can update the possible transport format tables, such an update is done by reconfiguration, which is very slow when comparing changes that can occur on the channel quality according to fast fading.

It would be desirable to implement a fast power scheduler entity for High Speed Packet Access to a base station.

### SUMMARY OF THE INVENTION

The present invention concerns an apparatus comprising a first circuit and a second circuit. The first circuit may be configured to generate an estimated power unit table used to store power information in response to one or more of a plurality of input parameters. The second circuit may be configured to individually allocate one or more power usage parameters to each of a plurality of mobile units through a wireless network in response to the parameters stored in said power unit table. The power usage parameters may comprise (i) an absolute power grant when in a first mode and (ii) a relative power grant when in a second mode.

The objects, features and advantages of the present invention include providing an apparatus that may (i) implement power grant allocation, (ii) implement a High Speed Uplink Packet Access (HSUPA) MAC scheduler, (iii) reduce the overall power used in a cellular system and/or (iv) reduce cost and/or overhead in a cellular system.

### BRIEF DESCRIPTION OF THE DRAWINGS

These and other objects, features and advantages of the present invention will be apparent from the following detailed description and the appended claims and drawings in which:

FIG. 1 is a diagram of a communications system;

FIG. 2 is a diagram of a base station in a communications system;

FIG. 3 is a diagram of a ranking process used in the MAC scheduler block of FIG. 2;

FIG. 4 is a diagram of a ranking process used in the power grant allocation block of FIG. 2.

### DETAILED DESCRIPTION OF THE PREFERRED EMBODIMENTS

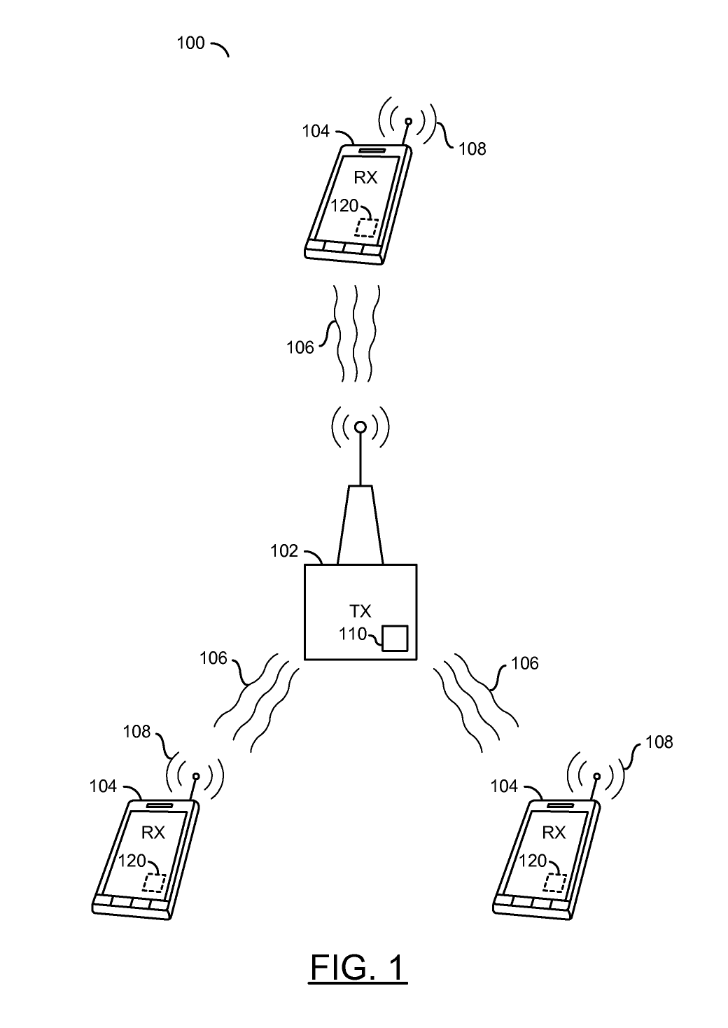

Referring to FIG. 1, a diagram of a system 100 is shown illustrating a communications system implemented in accordance with an example embodiment of the present invention. The system 100 may implement a wireless communications system. In one example, the system 100 may implement a third generation cellular communication system compliant with the 3GPP Wideband Code Division Multiple Access (WCDMA) standard. Future generations, such as 4G, may also be implemented.

The system 100 generally comprises at least one base station 102 and a number of mobile units (or UEs) 104a-104n. The base station 102 may transmit signals to the mobile units 104a-104n via a downlink channel 106. Each of the mobile units 104a-104n may transmit signals to the base station 102 via an uplink channel 108. The system 100 may also be implemented with multiple base stations 102. The base station(s) 102 may include a processing unit 110. Each of the mobile units 104a-104n may include a processing unit 120. The processing units 110 and 120 may be configured to manage communications between the base station(s) 102 and the mobile units 104a-104n.

The processing unit 110 may be configured to perform an iterative downlink process for code division multiple access. In one example, the processor 110 may implement hardware to perform the downlink processing in accordance with the present invention. In another example, the downlink processing in accordance with the present invention may be performed by software executed on the processing unit 110. In one example, the software for performing the downlink processing in accordance with the present invention may be written to a Flash memory or other nonvolatile memory (e.g., programmable read only memory (PROM), erasable programmable read only memory (EPROM), electrically erasable programmable read only memory (EEPROM), bubble memory, disk or disc media, etc.). Additionally, even volatile memory, such as dynamic random access memory (DRAM) or static random access memory (SRAM), may be used. For example, the software may be loaded from a non-volatile storage medium at power-up.

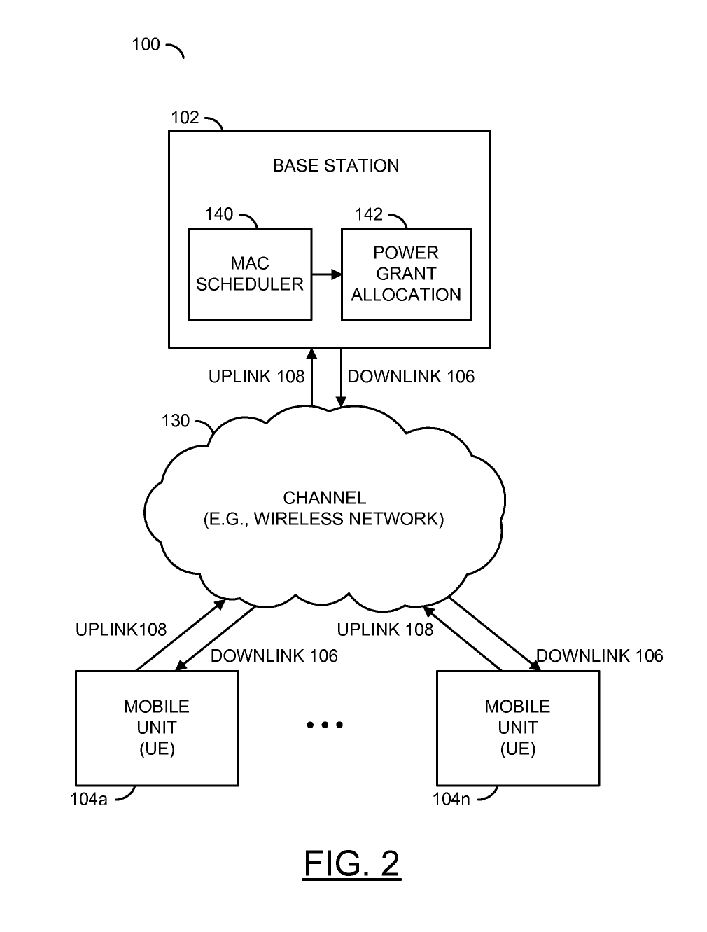

Referring to FIG. 2, a diagram is shown illustrating example components that may be employed by the base station 102 in processing a downlink signal 106 of the system 100. In general, the base station 102 may generate the downlink signal 106 that may be used, in one example, by mobile units 104. A channel 130 may be implemented, for example, as a wireless communications channel. In one example, the channel 130 may be implemented as a cellular communications channel of a wireless communications network (e.g., a 3GPP LTE network, 3GPP WCDMA, 4G, etc.). In one example, the base station 102 may include a block (or circuit) 140 and a block (or circuit) 142. The circuit 140 may be implemented as a MAC scheduler. The circuit 142 may be implemented as a power grant allocation circuit. In one example, the circuit 140 and the circuit 142 may be implemented within the processor 110 of FIG. 2.

In one example, the system 100 may implement a power grant allocation process that may be used in a WCDMA High Speed Uplink Packet Access (HSUPA) MAC scheduler. The system 100 may allocate power on a per mobile unit basis (compared with a conventional allocation grant made on a per HARQ basis). The system 100 may decrease the gap in power among the HARQ processes, which may decrease the peak to average of the received signals by the base station 100. The system 100 may reduce the processing time and/or increase channel utilization.

The system 100 may be split into High Speed Down Link Packet Access (HSDPA) portion and High Speed Uplink Packet Access (HSUPA) portion. The MAC scheduler 140 may be designated to allocate power to the connected mobile units 104a-104n. As the power allocation increases to each of the mobile units 104a-104n, the data rate increases.

The scheduler 140 may implement two options for granting power (i) an absolute grant (AG) and (ii) a relative grant (RG). An absolute grant may be defined as an absolute power allocation, where the particular mobile unit 104a-104n shall not exceed the value of the grant. A relative grant may be defined as relative change of the current grant. A relative grant may have one of the following possible values (i) a ‘down’ grant (which generally means decrease the power), (ii) a ‘hold’ grant (which generally means do not change the power) and (iii) an ‘up’ grant (which generally means increase the power). The ‘up’, ‘hold’ and ‘down’ grants may implement an index change of the current grant index. A current grant index is described in more detail in Ver. 25.321, section 9.2.5.2.1 v7.19.0 of the 3GPP specification, the appropriate portions of which are hereby incorporated by reference.

The base station 102 may send a grant allocation by using an absolute grant or a relative grant for each of a number of HARQ process for each of the mobile devices 104a-104n (e.g., each of the mobile devices 104a-104n may have 4 or 8 HARQ processes). The base station 102 normally determines a particular type (e.g., either AG or RG) and value of the power grant. Several parameters may be used to determine the grant type. For example, the remaining power of the mobile devices 104a-104n for transmission (a different value may be used per HARQ process), a buffer occupancy (BO) status of each of the mobile devices 104a-104n, a LCH priority of each of the mobile devices 104a-104n and/or a previous power grant allocation. According to one or more of such parameters, the base station 102 may rank the HARQ processes and/or allocate the power grant among the mobile units 104a-104n (e.g., the power budget is limited and the base station 102 normally needs to allocate the power resources among the HARQ processes of all mobile units 104a-104n).

In a straight forward implementation, each HARQ process may be ranked. Each process may be allocated separately (or independently) by the base station 102. The HARQ processes of the same one of the mobile devices 104a-104n may have a different ranking due to a different current grant (e.g., a current grant may be referred to as a serving grant). A different HARQ process belonging the same one of the mobile devices 104a-104n may receive a different grant allocation from the base station 102. Without the power grant allocation ranking of the system 100, the base station 102 may need to rank several elements (e.g., the number of mobile devices 104a-104n multiplied by the number of HARQ processes for each of the mobile devices 104a-104n).

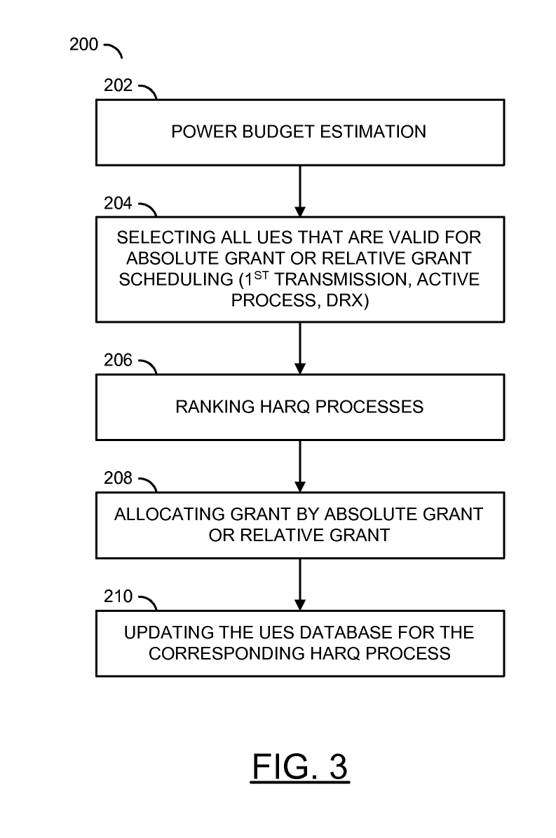

Referring to FIG. 3, a diagram illustrating a ranking method (or process) 200 is shown. The method 200 generally comprises a step (or state) 202, a step (or state) 204, a step (or state) 206, a step (or state) 208 and a step (or state) 210. The step 202 may be implemented as a power budget estimation for an HSUPA. The state 204 may be implemented to select all of the mobile units 104a-104n that are valid for an absolute grant or a relative grant (e.g., first transmission, active process, DRX, etc.). The step 206 may implement a ranking of one or more HARQ processes. The step 208 may be implemented to allocate a grant as an absolute grant or a relative grant. The step 210 may be implemented to update a mobile device database for each of a number of corresponding HARQ processes.

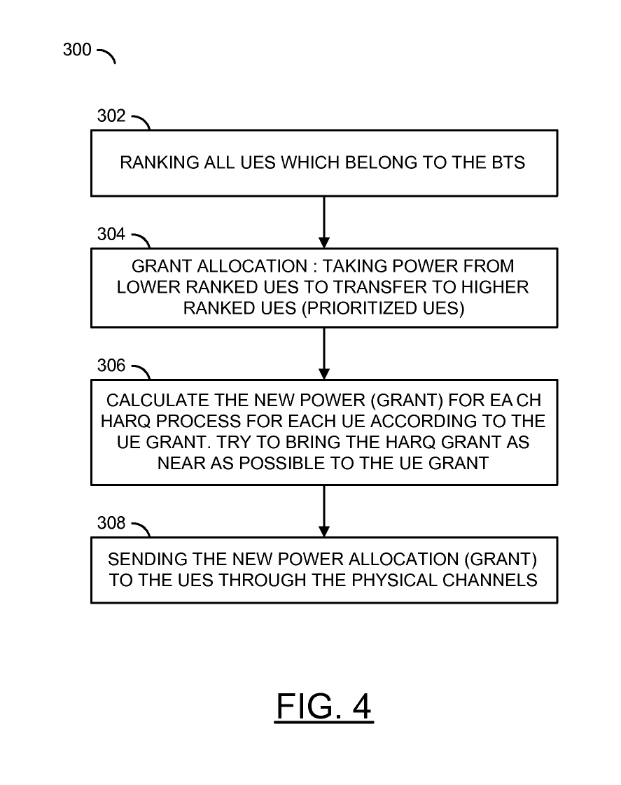

Referring to FIG. 4, a diagram of a method (or process) 300 is shown. The process 300 generally comprises a step (or state) 302, a step (or state) 304, a step (or state) 306 and a step (or state) 308. The step 302 may provide a ranking of all of the mobile units 104a-104n that belong to the base station 102. The step 304 may allocate a power grant between each of the mobile units 104a-104n. For example, power (e.g., a grant) may be taken (or transferred) from a lower ranked mobile unit 104a-104n and transferred to a higher ranked mobile unit 104a-104n (e.g., power is prioritized between the mobile units 104a-104n). Such a transfer may keep an overall power at a constant level. The step 306 may calculate a new power grant for each HARQ process (either an initial send or a retransmit) for each of the mobile units 104a-104n according to the power allocation of the step 304. The step 306 may limit the power grant of a HARQ process (either an initial or a retransmit) to be similar to the power grant calculated for a particular one of the mobile units 104a-104n. By limiting the power grant of a HARQ process to the original power grant of the particular one of the devices 104a-104n, a separate calculation for each HARQ process may be avoided. The step 308 may send a new power allocation grant to each HARQ process of each of the mobile units 104a-104n through the physical channels.

In order to decrease the list of elements for ranking (e.g., the number of mobile units 104a-104n multiplied by number of HARQ processes per unit 104a-104n), only the mobile units 104a-104n are ranked. An allocation grant for each of the mobile units 104a-104n is made only after the ranking. The original power grants are generally translated into a HARQ processing grant. By using the original power grant for each HARQ process, overall processing resources may be reduced. In a typical system, either 4 or 8 HARQ processes may be implemented. The system 100 may reduce processing resources used for ranking by 4 times, 8 times, etc. The stages of the ranking process may be described as follows:

In a first stage, the mobile units 104a-104n may be individually ranked (rather than ranking each of the individual HARQ processes) according to input parameters (e.g., UEs remaining power for transmission of a different value per HARQ process may be needed, so performing an average is normally needed), the buffer occupancy (BO) status of each of the mobile units 104a-104n, the LCH priority of each of the mobile units 104a-104n and/or previous grant allocation.

In a second stage, a ranking according to a ranking list may be preferred. A power grant may be allocated for each of the mobile units 104a-104n. The allocation may be a logical allocation since there is virtually no physical UE allocation, only HARQ allocation (e.g., there may be 4 or 8 HARQ processes per UE). The grant allocation per UE will be relative to a previous power grant allocation. In general, the higher ranked mobile device 104a-104n (calculated in the step 302) will normally receive ‘up’ (increasing the power) and the lower ranked UEs will receive ‘down’ (decreasing the power).

The UE power grant may be the average power of all the HARQ processes belonging to the same one of the mobile units 104a-104n. If the logical grant is selected as ‘up’, the circuit 140 may increase the average power by one step (e.g., according to the serving grant table of the 3GPP standard 25.321 v7.19.0 tables 9.2.5.2.1.1 and 9.2.5.2.1.1, which is incorporated by reference). If the logical grant is selected as ‘down’, the circuit 140 may decrease the average power by one step.

In a third stage, after updating the power grant for all the mobile units 104a-104n, the circuit 140 may compare between the UE grant and the HARQ grant. The circuit 140 may bring the power grant of the HARQ processes near the power grant of the particular mobile circuit 104a-104n. Such an implementation may be used to determine the real power grant for each HARQ process (e.g., a power change may be implemented by a real absolute and/or relative grant).

In a fourth stage, the circuit 140 may transmit the grant allocation to the mobile units 104a-104n through the physical layer 130. In general, a power grant may be allocated by ranking only the mobile units 104a-104n, which may significantly decrease the number of ranking list. Another advantage of the system 100 is to minimize the gap among the power of the HARQ processes of the same one of the mobile units 104a-104n, which decreases the peak to an average of the received signals on the base station 102, which may therefore increase the capacity.

In general, the defined standards mentioned above call for a physical layer of the physical channel 106 to calculate a power grant for each HARQ process. The system 100 allows a logical grant for each of the mobile units 104a-104n on a per unit basis by implementing the ranking step 206. The step 306 may then convert from a UE grant (to save resources) into a HARQ grant (to comply with the defined standards). A separate calculation for each HARQ grant (which may be 4, 8, etc. per UE grant) may be avoided.

The HSUPA MAC scheduler 140 may allocate power for all the HARQ processes of all the mobile devices 104a-104n for transmission of data. According to a given grant, a data size for a particular one of the mobile devices 104a-104n may be calculated and further transmitted in one TTI period (e.g., 2 ms or 10 ms). The particular one of the mobile units 104a-104n may be configured in advance to use either a 2 ms or 10 ms TTI (or other TTI). In one example, a particular one of the mobile units 104a-104n may be configured with a 10 ms TTI, with 4 HARQ processes implemented (e.g., 0, 1, 2, 3). The UE may transmit one HARQ process in one TTI, where the HARQ process is the data transmission. Such a transmission may be either an initial (e.g., 1^{st}) transmission, or a subsequent transmission (e.g., retransmission). In many cases, such a transmission may be an initial transmission.

The HARQ processes may be transmitted one after another and/or periodicity. In an example of 4 processes and a 10 ms TTI, each of the processes may have a period of 40 ms. If the HARQ processes number 0 is transmitted, the transmission will return to processes number 0 after 40 ms. In an example of 4 processes and 10 ms TTI, data may be transmitted in HARQ processes number 1. After 40 ms, another subsequent transmission occurs. If the transmission that occurs 40 ms previously has been received successfully, a retransmission is not needed and new data may be transmitted.

In general, the HARQ mechanism according to the defined standards mentioned above was initially designated to support quick retransmission. In the context of the system 100, a HARQ process is normally referred to as a time interval for transmission of new data (1st transmission) or, if needed, a subsequent transmission (retransmission) of the same data.

While the invention has been particularly shown and described with reference to the preferred embodiments thereof, it will be understood by those skilled in the art that various changes in form and details may be made without departing from the scope of the invention.

1. An apparatus comprising:
a first circuit configured to generate an estimated power unit table used to store power information in response to one or more of a plurality of input parameters; and
a second circuit configured to individually allocate one or more power usage parameters to each of a plurality of mobile units through a wireless network in response to said parameters stored in said power unit table, wherein said power usage parameters comprise (i) an absolute power grant when in a first mode and (ii) a relative power grant when in a second mode.

2. The apparatus according to claim 1, wherein said power usage parameters calculated for each of said plurality of mobile devices are converted to a plurality of Hybrid Automatic Repeat Requests (HARQ) transmitted within a period.

3. The apparatus according to claim 2, wherein an average of said plurality of HARQ processes is equal to or less than said calculated power usage parameter.

4. The apparatus according to claim 1, wherein said power usage parameters to each of said plurality of mobile devices are used for both an initial transmission and an average of one or more subsequent retransmissions.

5. The apparatus according to claim 1, wherein said relative power grant increases a previous power grant.

6. The apparatus according to claim 1, wherein said relative grant decreases the previous power grant.

7. The apparatus according to claim 1, wherein said absolute power grant is made without regard to a previous power grant.

8. The apparatus according to claim 1, wherein said plurality of input parameters include a remainder needed for transmission.

9. The apparatus according to claim 1, wherein said power usage table ranks each of said plurality of mobile units and allocates said power usage parameters according to said ranking.

10. The apparatus according to claim 1, wherein said estimated power unit table is implemented as a database.

11. The apparatus according to claim 1, wherein said first circuit comprises a MAC scheduler.

12. The apparatus according to claim 1, wherein said second circuit comprises a power grid allocation circuit.

13. An apparatus comprising:
means for generating an estimated power unit table used to store power information in response to one or more of a plurality of input parameters; and
means for individually allocating one or more power usage parameters to each of a plurality of mobile units through a wireless network in response to said parameters stored in said power unit table, wherein said power usage parameters comprise (i) an absolute power grant when in a first mode and (ii) a relative power grant when in a second mode.

14. A method for controlling the grant of power in a controller, comprising the steps of:
generating an estimated power unit table used to store power information in response to one or more of a plurality of input parameters; and
individually allocating one or more power usage parameters to each of a plurality of mobile units through a wireless network in response to said parameters stored in said power unit table, wherein said power usage parameters comprise (i) an absolute power grant when in a first mode and (ii) a relative power grant when in a second mode.
